(19) United States
(12) Patent Application Publication
(10) Pub. No.: US 2022/0398956 A1
(43) Pub. Date: Dec. 15, 2022

(54) METHODS AND APPARATUSES FOR DRIVING ELECTRO-OPTIC DISPLAYS

(71) Applicant: E INK CALIFORNIA, LLC, Fremont, CA (US)

(72) Inventors: Craig LIN, Fremont, CA (US); Ming WANG, Fremont, CA (US)

(21) Appl. No.: 17/806,599

(22) Filed: Jun. 13, 2022

Related U.S. Application Data
(60) Provisional application No. 63/210,227, filed on Jun. 14, 2021.

(51) Int. Cl. G09G 3/00; G09G 3/34; G06K 7/14

(52) U.S. Cl. CPC G09G 3/007; G09G 3/344; G06K 7/1443; G09G 2320/0257

(57) ABSTRACT

The invention provides methods and related apparatuses for reducing an edge effect in an image displayed on an electrophoretic display having an array of pixels by displaying an image made up of a plurality of pixels on a first subset of the array of pixels and shifting the value of each image pixel by one position in a first horizontal direction and a first vertical direction such that the image is identical but shifted in position to a second subset of the pixel array. The method also includes shifting the value of each image pixel by one position in a second horizontal direction and a second vertical direction where the second horizontal direction is opposite the first horizontal direction, and the second vertical direction is opposite the first vertical direction, whereby the image displayed is identical but shifted in position back to the first subset of the array of pixels.

### CROSS REFERENCE TO RELATED APPLICATIONS

This application claims priority to U.S. Provisional Patent Application No. 63/210,227, filed Jun. 14, 2021, which is incorporated by reference herein in its entirety. The entire contents of any patent, published application, or other published work referenced herein are incorporated by reference in their entireties.

### BACKGROUND OF THE INVENTION

Particle-based electrophoretic displays have been the subject of intense research and development for a number of years. In such displays, a plurality of charged particles (sometimes referred to as pigment particles) move through a fluid under the influence of an electric field. The electric field is typically provided by a conductive film or a transistor, such as a field-effect transistor. Electrophoretic displays have good brightness and contrast, wide viewing angles, state bistability, and low power consumption when compared with liquid crystal displays. Such electrophoretic displays have slower switching speeds than LCD displays, however, and electrophoretic displays are typically too slow to display real-time video. Additionally, the electrophoretic displays can be sluggish at low temperatures because the viscosity of the fluid limits the movement of the electrophoretic particles. Despite these shortcomings, electrophoretic displays can be found in everyday products such as electronic books (e-readers), mobile phones and mobile phone covers, smart cards, signs, watches, shelf labels, and flash drives.

Many commercial electrophoretic media essentially display only two colors, with a gradient between the black and white extremes, known as “grayscale.” Such electrophoretic media either use a single type of electrophoretic particle having a first color in a colored fluid having a second, different color (in which case, the first color is displayed when the particles lie adjacent the viewing surface of the display and the second color is displayed when the particles are spaced from the viewing surface), or first and second types of electrophoretic particles having differing first and second colors in an uncolored fluid. In the latter case, the first color is displayed when the first type of particles lie adjacent the viewing surface of the display and the second color is displayed when the second type of particles lie adjacent the viewing surface). Typically the two colors are black and white.

Although seemingly simple, electrophoretic media and electrophoretic devices display complex behaviors. For instance, it has been discovered that simple “on/off” voltage pulses are insufficient to achieve high-quality text in electronic readers. For example, one issue that contributes to the poor display quality is the “ghost images” (faint copies of previous images) or “ghosting” effect on the display. Such ghost images are distracting to the user, and reduce the perceived quality of the image, especially after multiple updates. One situation where such ghost images are a problem is when an electronic book reader is used to scroll through an electronic book, as opposed to jumping between separate pages of the book. As such, there exists a need to reduce this ghosting or ghost image effect in electro-optic displays.

### SUMMARY OF THE INVENTION

The methods and apparatuses described herein includes features for reducing or mitigating edge artifacts such as ghosting in images displayed on electro-optic displays.

In one aspect, the invention includes a method for reducing an edge effect in an image displayed on an electrophoretic display having an array of pixels. The method includes displaying an image made up of a plurality of pixels on a first subset of the array of pixels and shifting the value of each of the plurality of pixels by one pixel position in a first horizontal direction and one pixel position in a first vertical direction such that the image is identical but shifted in position to a second subset of the array of pixels. The method also includes shifting the value of each of the plurality of pixels by one pixel position in a second horizontal direction and one pixel position in a second vertical direction where the second horizontal direction is opposite to that of the first horizontal direction, and the second vertical direction is opposite to that of the first vertical direction, whereby the image is identical but shifted in position to the first subset of the array of pixels.

In some embodiments, the method includes shifting the value of each of the plurality of pixels by one pixel position in the second horizontal direction and one pixel position in the second vertical direction such that the image is identical but shifted in position to a second subset of the array of pixels, and shifting the value of each of the plurality of pixels by one pixel position in the first horizontal direction and one pixel position in the first vertical direction such that the image is identical but shifted in position to the first subset of the array of pixels.

In some embodiments, the method includes shifting the value of each of the plurality of pixels by one pixel position in the first horizontal direction and one pixel position in the second vertical direction such that the image is identical but shifted in position to a fourth subset of the array of pixels, and shifting the value of each of the plurality of pixels by one pixel position in the second horizontal direction and one pixel position in the first vertical direction such that the image is identical but shifted in position to the first subset of the array of pixels.

In some embodiments, the method includes shifting the value of each of the plurality of pixels by one pixel position in the second horizontal direction and one pixel position in the first vertical direction such that the image is identical but shifted in position to a fifth subset of the array of pixels, and shifting the value of each of the plurality of pixels by one pixel position in the first horizontal direction and one pixel position in the second vertical direction such that the image is identical but shifted in position to the first subset of the array of pixels.

In some embodiments, the array of pixels includes at least one more pixel than the image in the first horizontal direction. In some embodiments, the array of pixels includes at least one more pixel than the image in the first vertical direction. In some embodiments, the array of pixels includes at least one more pixel than the image in the second horizontal direction. In some embodiments, the array of pixels includes at least one more pixel than the image in the second vertical direction. In some embodiments, the array of pixels is organized as a two-dimensional array of rows and columns.

In some embodiments, the image includes a bar code. In some embodiments, the edge effect comprises ghosting between at least two bars of the bar code.

In another aspect, the invention includes an electrophoretic display including an array of pixels positioned in a plurality of rows and columns, and a controller in electrical communication with the array of pixels. The controller is configured to reduce an edge effect in an image displayed on the array of pixels by displaying the image comprising a plurality of pixels on a subset of the array of pixels, shifting the value of each of the plurality of pixels by one pixel position in a first horizontal direction and one pixel position in a first vertical direction, and shifting the value of each of the plurality of pixels by one pixel position in a second horizontal direction and one pixel position in a second vertical direction, where the second horizontal direction is opposite to that of the first horizontal direction, and the second vertical direction is opposite to that of the first vertical direction.

In some embodiments, the controller is further configured to shift the value of each of the plurality of pixels by one pixel position in the second horizontal direction and one pixel position in the second vertical direction, and shift the value of each of the plurality of pixels by one pixel position in the first horizontal direction and one pixel position in the first vertical direction.

In some embodiments, the controller is further configured to shift the value of each of the plurality of pixels by one pixel position in the first horizontal direction and one pixel position in the second vertical direction, and shift the value of each of the plurality of pixels by one pixel position in the second horizontal direction and one pixel position in the first vertical direction.

In some embodiments, the controller is further configured to shift the value of each of the plurality of pixels by one pixel position in the second horizontal direction and one pixel position in the first vertical direction, and shift the value of each of the plurality of pixels by one pixel position in the first horizontal direction and one pixel position in the second vertical direction.

In some embodiments, the array of pixels includes at least one more pixel than the image in the first horizontal direction. In some embodiments, the array of pixels includes at least one more pixel than the image in the first vertical direction. In some embodiments, the array of pixels includes at least one more pixel than the image in the second horizontal direction. In some embodiments, the array of pixels includes at least one more pixel than the image in the second vertical direction. In some embodiments, the array of pixels is organized as a two-dimensional array of rows and columns.

In some embodiments, the image includes a bar code. In some embodiments, the edge effect comprises ghosting between at least two bars of the bar code.

In another aspect, the invention includes a method for reducing an edge effect in an image displayed on an electrophoretic display having an array of pixels organized as a two-dimensional array of row pixels and column pixels. The method includes the step of (a) defining a boundary box within the array of pixels, where the boundary box includes a plurality of row pixels and a plurality of column pixels. The method also includes the step of (b) displaying the image on a first subset of the array of pixels, where the first subset of the array of pixels comprises two fewer row pixels and two fewer column pixels than the boundary box. The method also includes the step of (c) shifting the value of each pixel of the first subset of the array of pixels by one row pixel and one column pixel such that the image is identical but shifted in position relative to the first subset of the array of pixels by one of (i) one row pixel to the left and one column pixel upward, (ii) one row pixel to the right and one column pixel downward, (iii) one row pixel to the left and one column pixel downward, or (iv) one row pixel to the right and one column pixel upward. The method also includes the step of (d) shifting the value of each pixel of the second subset of the array of pixels by one row pixel and one column pixel such that the image is identical but shifted in position back to the first subset of the array of pixels. The method includes the step of (e) performing one of step (c) or step (d) alternately during each subsequent update to the electrophoretic display such that the image is only displayed within the boundary box where each time step (c) is performed the image is shifted in position relative to the first subset of the array of pixels by a different one of (i)-(iv) than the previous time step (c) was performed.

In some embodiments, the boundary box comprises the same number of pixels as the electrophoretic display. In some embodiments, the image includes a bar code. In some embodiments, the edge effect comprises ghosting between at least two bars of the bar code.

In another aspect, the invention includes an electrophoretic display including an array of pixels organized as a two-dimensional array of row pixels and column pixels, and a controller in electrical communication with the array of pixels. The controller is configured to reduce an edge effect in an image displayed on the array of pixels by (a) defining a boundary box within the array of pixels, the boundary box comprising a plurality of row pixels and a plurality of column pixels, (b) displaying the image on a first subset of the array of pixels, wherein the first subset of the array of pixels comprises two fewer row pixels and two fewer column pixels than the boundary box, (c) shifting the value of each pixel of the first subset of the array of pixels by one row pixel and one column pixel such that the image is identical but shifted in position relative to the first subset of the array of pixels by one of (i) one row pixel to the left and one column pixel upward, (ii) one row pixel to the right and one column pixel downward, (iii) one row pixel to the left and one column pixel downward, or (iv) one row pixel to the right and one column pixel upward, (d) shifting the value of each pixel of the second subset of the array of pixels by one row pixel and one column pixel such that the image is identical but shifted in position back to the first subset of the array of pixels, and (e) performing one of step (c) or step (d) alternately during each subsequent update to the electrophoretic display such that the image is only displayed within the boundary box, where each time step (c) is performed the image is shifted in position relative to the first subset of the array of pixels by a different one of (i)-(iv) than the previous time step (c) was performed.

In some embodiments, the boundary box comprises the same number of pixels as the electrophoretic display. In some embodiments, the image includes a bar code. In some embodiments, the edge effect includes ghosting between at least two bars of the bar code.

### BRIEF DESCRIPTION OF DRAWINGS

Additional details of one or more embodiments of the subject matter described in this specification are set forth in the accompanying drawings and the description below. Other features, aspects, and advantages of the subject matter will become apparent from the descriptions contained herein and the accompanying drawings. The drawings are not necessarily to scale and elements of similar structures are generally annotated with like reference numerals for illustrative purposes throughout the drawings. However, the specific properties and functions of elements in different embodiments may not be identical. Further, the drawings are only intended to facilitate the description of the subject matter. The drawings do not necessarily illustrate every aspect of the described embodiments and do not limit the scope of the present disclosure or claims.

FIG. 1 illustrates an electrophoretic display in accordance with the subject matter disclosed herein;

FIG. 2 illustrates an equivalent circuit of the electrophoretic display presented in FIG. 1 in accordance with the subject matter disclosed herein;

FIG. 3 illustrates an exemplary bar code image in accordance with the subject matter disclosed herein;

FIGS. 4a to 4d are illustrations of an update sequence in accordance with the subject matter presented herein; and

FIGS. 5a and 5b are illustrations of exemplary steps of an update sequence incorporating a boundary box in accordance with the subject matter presented herein;

### DETAILED DESCRIPTION OF THE INVENTION

As indicated above, the subject matter presented herein provides methods and means to reduce charge built up in the electrophoretic display medium and improve electro-optic display performances.

The term “electro-optic” as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in published US Patent Application No. 2002/0180687 (see also the corresponding International Application Publication No. WO 02/079869) that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

The term “impulse” is used herein in its conventional meaning of the integral of voltage with respect to time. However, some bistable electro-optic media act as charge transducers, and with such media an alternative definition of impulse, namely the integral of current over time (which is equal to the total charge applied) may be used. The appropriate definition of impulse should be used, depending on whether the medium acts as a voltage-time impulse transducer or a charge impulse transducer.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspension medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example United States Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. D485,294; 6,124,851; 6,130,773; 6,177,921; 6,232,950; 6,252,564; 6,312,304; 6,312,971; 6,376,828; 6,392,786; 6,413,790; 6,422,687; 6,445,374; 6,480,182; 6,498,114; 6,506,438; 6,518,949; 6,521,489; 6,535,197; 6,545,291; 6,639,578; 6,657,772; 6,664,944; 6,680,725; 6,683,333; 6,724,519; 6,750,473; 6,816,147; 6,819,471; 6,825,068; 6,831,769; 6,842,167; 6,842,279; 6,842,657; 6,865,010; 6,873,452; 6,909,532; 6,967,640; 6,980,196; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,280,094; 7,301,693; 7,304,780; 7,327,511; 7,347,957; 7,349,148; 7,352,353; 7,365,394; 7,365,733; 7,382,363; 7,388,572; 7,401,758; 7,442,587; 7,492,497; 7,535,624; 7,551,346; 7,554,712; 7,583,427; 7,598,173; 7,605,799; 7,636,191; 7,649,674; 7,667,886; 7,672,040; 7,688,497; 7,733,335; 7,785,988; 7,830,592; 7,843,626; 7,859,637; 7,880,958; 7,893,435; 7,898,717; 7,905,977; 7,957,053; 7,986,450; 8,009,344; 8,027,081; 8,049,947; 8,072,675; 8,077,141; 8,089,453; 8,120,836; 8,159,636; 8,208,193; 8,237,892; 8,238,021; 8,362,488; 8,373,211; 8,389,381; 8,395,836; 8,437,069; 8,441,414; 8,456,589; 8,498,042; 8,514,168; 8,547,628; 8,576,162; 8,610,988; 8,714,780; 8,728,266; 8,743,077; 8,754,859; 8,797,258; 8,797,633; 8,797,636; 8,830,560; 8,891,155; 8,969,886; 9,147,364; 9,025,234; 9,025,238; 9,030,374; 9,140,952; 9,152,003; 9,152,004; 9,201,279; 9,223,164; 9,285,648; and 9,310,661; and U.S. Patent Applications Publication Nos. 2002/0060321; 2004/0008179; 2004/0085619; 2004/0105036; 2004/0112525; 2005/0122306; 2005/0122563; 2006/0215106; 2006/0255322; 2007/0052757; 2007/0097489; 2007/0109219; 2008/0061300; 2008/0149271; 2009/0122389; 2009/0315044; 2010/0177396; 2011/0140744; 2011/0187683; 2011/0187689; 2011/0292319; 2013/0250397; 2013/0278900; 2014/0078024; 2014/0139501; 2014/0192000; 2014/0210701; 2014/0300837; 2014/0368753; 2014/0376164; 2015/0171112; 2015/0205178; 2015/0226986; 2015/0227018; 2015/0228666; 2015/0261057; 2015/0356927; 2015/0378235; 2016/077375; 2016/0103380; and 2016/0187759; and International Application Publication No. WO 00/38000; European Patents Nos. 1,099,207 B1 and 1,145,072 B1;
(g) Color formation and color adjustment; see for example U.S. Pat. Nos. 7,075,502 and 7,839,564;
(h) Methods for driving displays; see for example U.S. Pat. Nos. 7,012,600 and 7,453,445;
(i) Applications of displays; see for example U.S. Pat. Nos. 7,312,784 and 8,009,348;
(j) Non-electrophoretic displays, as described in U.S. Pat. Nos. 6,241,921; and U.S. Patent Applications Publication No. 2015/0277160; and U.S. Patent Application Publications Nos. 2015/0005720 and 2016/0012710.

All of the above patents and patent applications are incorporated herein by reference in their entireties.

Many of the aforementioned patents and applications recognize that the walls surrounding the discrete microcapsules in an encapsulated electrophoretic medium could be replaced by a continuous phase, thus producing a so-called polymer-dispersed electrophoretic display in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; inkjet printing processes; and other similar techniques.) Thus, the resulting display can be flexible. Further, because the display medium can be printed (using a variety of methods), the display itself can be made inexpensively.

A related type of electrophoretic display is a so-called “microcell electrophoretic display”. In a microcell electrophoretic display, the charged particles and the suspending fluid are not encapsulated within microcapsules but instead are retained within a plurality of cavities formed within a carrier medium, typically a polymeric film. See, for example, International Application Publication No. WO 02/01281, and published U.S. Application No. 2002/0075556, both assigned to Sipix Imaging, Inc.

The aforementioned types of electro-optic displays are bistable and are typically used in a reflective mode, although as described in certain of the aforementioned patents and applications, such displays may be operated in a “shutter mode” in which the electro-optic medium is used to modulate the transmission of light, so that the display operates in a transmissive mode. Liquid crystals, including polymer-dispersed liquid crystals, are, of course, also electro-optic media, but are typically not bistable and operate in a transmissive mode. Certain embodiments of the invention described below are confined to use with reflective displays, while others may be used with both reflective and transmissive displays, including conventional liquid crystal displays.

Whether a display is reflective or transmissive, and whether or not the electro-optic medium used is bistable, to obtain a high-resolution display, individual pixels of a display must be addressable without interference from adjacent pixels. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a voltage such as to ensure that all the transistors in the selected row are conductive, while there is applied to all other rows a voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.) After a pre-selected interval known as the “line address time” the selected row is deselected, the next row is selected, and the voltages on the column drivers are changed to that the next line of the display is written. This process is repeated so that the entire display is written in a row-by-row manner.

Processes for manufacturing active matrix displays are well established. Thin-film transistors, for example, can be fabricated using various deposition and photolithography techniques. A transistor includes a gate electrode, an insulating dielectric layer, a semiconductor layer and source and drain electrodes. Application of a voltage to the gate electrode provides an electric field across the dielectric layer, which dramatically increases the source-to-drain conductivity of the semiconductor layer. This change permits electrical conduction between the source and the drain electrodes. Typically, the gate electrode, the source electrode, and the drain electrode are patterned. In general, the semiconductor layer is also patterned in order to minimize stray conduction (i.e., cross-talk) between neighboring circuit elements.

Liquid crystal displays commonly employ amorphous silicon (“a-Si”), thin-film transistors (“TFT's”) as switching devices for display pixels. Such TFT's typically have a bottom-gate configuration. Within one pixel, a thin film capacitor typically holds a charge transferred by the switching TFT. Electrophoretic displays can use similar TFT's with capacitors, although the function of the capacitors differs somewhat from those in liquid crystal displays; see the aforementioned copending application Ser. No. 09/565,413, and Publications 2002/0106847 and 2002/0060321. Thin film transistors can be fabricated to provide high performance. Fabrication processes, however, can result in significant cost.

In TFT addressing arrays, pixel electrodes are charged via the TFTs during a line address time. During the line address time, a TFT is switched to a conducting state by changing an applied gate voltage. For example, for an n-type TFT, a gate voltage is switched to a “high” state to switch the TFT into a conducting state.

Furthermore, unwanted effect such as voltage shifts may be caused by crosstalk occurring between a data line supplying driving waveforms to the display pixel and the pixel electrode. Similar to the voltage shift described above, crosstalk between the data line and the pixel electrode can be caused by capacitive coupling between the two even when the display pixel is not being addressed (e.g., associated pixel TFT in depletion). Such crosstalk can result in voltage shifts that are undesirable because it can lead to optical artifacts such as image streaking.

In some cases, an electrophoretic display or EPD may include two substrates (e.g., plastic or glass) where a front plane laminate or FPL is positioned between the two substrates. In some embodiments, the bottom portion of the top substrate may be coated with a transparent conductive material to function as a conductive electrode (i.e., the Vcom plane). The top portion of the lower substrate may include an array of electrode elements (e.g., conductive electrodes for each display pixels). A semiconductor switch, such as a thin film transistor or TFT, may be associated with each of these pixel electrodes. Application of a bias voltage to a pixel electrode and the Vcom plane may result in an electro-optical transformation of the FPL. This optical transformation can be used as a basis for the display of text or graphical information on the EPD. To display a desired image, a proper voltage needs to be applied to each pixel electrode.

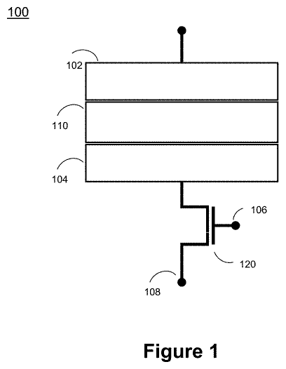

FIG. 1 illustrates a schematic model of a display pixel 100 of an electro-optic display in accordance with the subject matter presented herein. Pixel 100 may include an imaging film 110. In some embodiments, imaging film 110 may be a layer of electrophoretic material and bistable in nature. This electrophoretic material may include a plurality of electrically charged color pigment particles (e.g., black, white, yellow or red) disposed in a fluid and capable of moving through the fluid under the influence of an electric field. In some embodiments, imaging film 110 may be an electrophoretic film having micro-cells with charged pigment particles. In some other embodiments, imaging film 110 may include, without limitation, an encapsulated electrophoretic imaging film, which may include, for example, charged pigment particles. It should be appreciated that the driving method presented below may be easily adopted for either types of electrophoretic material (e.g., encapsulated or film with micro-cells).

In some embodiments, imaging film 110 may be disposed between a front electrode 102 and a rear or pixel electrode 104. Front electrode 102 may be formed between the imaging film and the front of the display. In some embodiments, front electrode 102 may be transparent and light-transmissive. In some embodiments, front electrode 102 may be formed of any suitable transparent material, including, without limitation, indium tin oxide (ITO). Rear electrode 104 may be formed on an opposed side of the imaging film 110 to the front electrode 102. In some embodiments, a parasitic capacitance (not shown) may be formed between front electrode 102 and rear electrode 104.

Pixel 100 may be one of a plurality of pixels. The plurality of pixels may be arranged in a two-dimensional array of rows and columns to form a matrix, such that any specific pixel is uniquely defined by the intersection of one specified row and one specified column. In some embodiments, the matrix of pixels may be an “active matrix,” in which each pixel is associated with at least one non-linear circuit element 120. The non-linear circuit element 120 may be coupled between back-plate electrode 104 and an addressing electrode 108. In some embodiments, non-linear element 120 may be a diode and/or a transistor, including, without limitation, a MOSFET or a Thin-Film Transistor (TFT). The drain (or source) of the MOSFET or TFT may be coupled to back-plate or pixel electrode 104, the source (or drain) of the MOSFET or TFT may be coupled to the addressing electrode 108, and the gate of the MOSFET or TFT may be coupled to a driver electrode 106 configured to control the activation and deactivation of the MOSFET or TFT. (For simplicity, the terminal of the MOSFET or TFT coupled to back-plate electrode 104 will be referred to as the MOSFET or TFT's drain, and the terminal of the MOSFET or TFT coupled to addressing electrode 108 will be referred to as the MOSFET or TFT's source. However, one of ordinary skill in the art will recognize that, in some embodiments, the source and drain of the MOSFET or TFT may be interchanged.)

In some embodiments of the active matrix, the addressing electrodes 108 of all the pixels in each column may be connected to a same column electrode, and the driver electrodes 106 of all the pixels in each row may be connected to a same row electrode. The row electrodes may be connected to a row driver, which may select one or more rows of pixels by applying to the selected row electrodes a voltage sufficient to activate the non-linear elements 120 of all the pixels 100 in the selected row(s). The column electrodes may be connected to column drivers, which may place upon the addressing electrode 106 of a selected (activated) pixel a voltage suitable for driving the pixel into a desired optical state. The voltage applied to an addressing electrode 108 may be relative to the voltage applied to the pixel's front-plate electrode 102 (e.g., a voltage of approximately zero volts). In some embodiments, the front-plate electrodes 102 of all the pixels in the active matrix may be coupled to a common electrode.

In use, the pixels 100 of the active matrix may be written in a row-by-row manner. For example, a row of pixels may be selected by the row driver, and the voltages corresponding to the desired optical states for the row of pixels may be applied to the pixels by the column drivers. After a pre-selected interval known as the “line address time,” the selected row may be deselected, another row may be selected, and the voltages on the column drivers may be changed so that another line of the display is written.

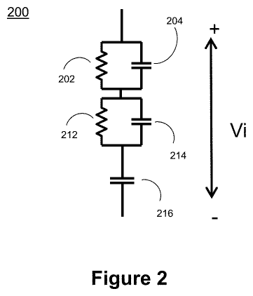

FIG. 2 illustrates a circuit model of the electro-optic imaging layer 110 disposed between the front electrode 102 and the rear electrode 104 in accordance with the subject matter presented herein. Resistor 202 and capacitor 204 may represent the resistance and capacitance of the electro-optic imaging layer 110, the front electrode 102 and the rear electrode 104, including any adhesive layers. Resistor 212 and capacitor 214 may represent the resistance and capacitance of a lamination adhesive layer. Capacitor 216 may represent a capacitance that may form between the front electrode 102 and the back electrode 104, for example, interfacial contact areas between layers, such as the interface between the imaging layer and the lamination adhesive layer and/or between the lamination adhesive layer and the backplane electrode. A voltage Vi across a pixel's imaging film 110 may include the pixel's remnant voltage.

In use, some electro-optic displays such as an electrophoretic display depicted by FIGS. 1 and 2 may suffer from a unique case of edge ghosting. For example, when a particular image is updated over and over again on an electrophoretic display such as an electronic shelf label (ESL), when an image such as a bar code is updated repeatedly on a portion of the ESL, ghosting may appear between the bars of the bar code image due to the pixels are biased with +15 volts on the left and −15 volts on the right.

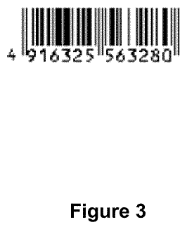

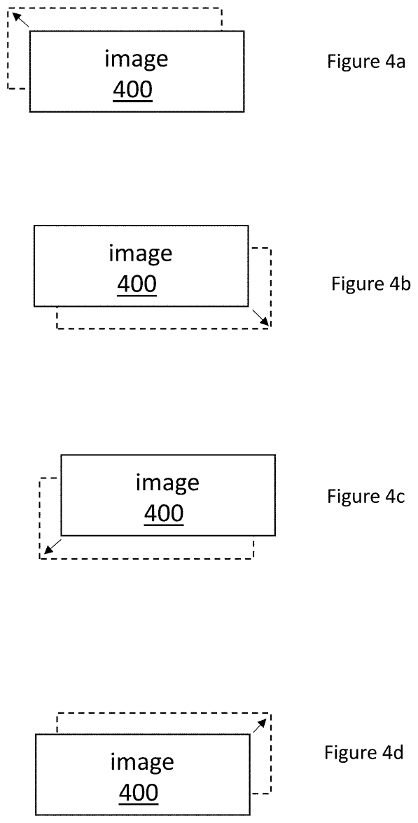

In one embodiment, an image may be “altered” or shifted every update to mitigate the ghosting issue. For example, during a first update, the bar code 400 as shown in FIG. 3 may be shifted one pixel left and one pixel up (See FIG. 4a), and during a subsequent second update the entire bar code image 400 may be moved back to the original position. In another embodiment, a third update can move the bar code 400 one pixel right and one pixel down (See FIG. 4b), followed by a fourth update that will move the bar code 400 image back to the original position. In yet another embodiment, a fifth update can move the bar code image 400 one pixel to the left and down (See FIG. 4c), followed by a sixth update to move the bar code image 400 back to the original position. In another embodiment, a seventh update can move the bar code image 400 one pixel to the right and up (See FIG. 4d), followed by a eighth update to move the bar code image 400 back to the original position.

The above mentioned process can be repeated either in that exact sequence, or a combination of, for numerous cycles (e.g., 50 updates). An experiment was conducted to determine whether the inventive process described herein resulted in a reduction in ghosting in the image of a bar code (e.g., FIG. 3). A bar code image was updated 50 times unaltered, meaning there was no shifting of the image as described above. Separately, an identical bar code image was updated 50 times using the shift or altering sequence described above. Using the shift or altering sequence reduced the ghosting effect in the image of the bar code as compared to the image of the bar code that was updated 50 times unaltered.

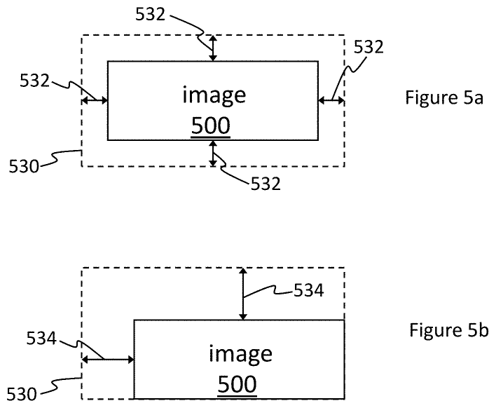

FIGS. 5a and 5b are illustrations of exemplary steps of an update sequence for reducing an edge effect such as the edge ghosting between the bars of a bar code described above. A controller (e.g., row and column driver) can be configured to define a boundary box 530 within the display's array of row and columns pixels. The boundary box 530 is made up of several contiguous row and column pixels of the display, and delineates the portion of the display on which an image 500 is displayed during the update sequence. However, the boundary box 530 is an element or data structure defined in software and is not visible on the display.

The boundary box 530 can include a subset of the row and column pixels of the display. In some embodiments, the boundary box 530 includes every row and column pixel of the viewable area of the display. In some embodiments, multiple boundary boxes 530 are defined within the display, and an update sequence is performed on the images displayed within each boundary box 530.

The update sequence incorporating the boundary box 530 is similar to the update sequence described above in connection with FIGS. 4a-4d. For example, in order to have the requisite space be able to shift the image 500 within the boundary box 530 during the update sequence, the image 500 that is displayed within the boundary box 530 must occupy at least two fewer row pixels and two fewer columns pixels than the boundary box 530. FIG. 5a illustrates the image 500 displayed at an initial position within the boundary box 530. As shown in FIG. 5a, the image 500 is smaller than the boundary box 530 by one pixel size 532 in both horizontal (column) directions and both vertical (row) directions.

The update sequence continues much as described above. During an update to the display, the value of each pixel of the image 500 is shifted by one row pixel and one column pixel such that the image being displayed is identical to image 500 but is shifted in position relative to its initial position within the boundary box 530. For example, each pixel could be shifted: (i) one row pixel to the left and one column pixel upward, (ii) one row pixel to the right and one column pixel downward, (iii) one row pixel to the left and one column pixel downward, or (iv) one row pixel to the right and one column pixel upward. FIG. 5b illustrates the image 500 displayed within the boundary box 530 after being shifted one row pixel to the right and one column pixel downward (similar to FIG. 4b described above). As shown in FIG. 5b, the image 500 is now positioned two pixel sizes 534 from the left edge of the boundary box 530, and two pixel sizes 534 from the top edge of the boundary box 530.

During the following update to the display, the image 500 is shifted back to its initial position. For example, during the next update the image 500 shown in FIG. 5b is shifted one row pixel to the left and one column pixel upward and would again appear at the position shown in FIG. 5a.

The update sequence continues to alternate between shifting the image 500 according to one of the shift patterns (i)-(iv) during an update to the display, and then shifting the image 500 back to its initial position during the subsequent update. The shift patterns (i)-(iv) can be performed in any order during the update sequence, however, a different shift pattern is selected each time the image 500 is being shifted from its initial position (FIG. 5a). For example, the image 500 shown in FIG. 5b resulted from the image 500 in FIG. 5a being shifted according to pattern (ii). Accordingly, during the next update in which the image 500 is shifted from its initial position, one of patterns (i), (iii), or (iv) would be selected.

The embodiments described above provide advantages over conventional methods for reducing edge effects. For example, conventional methods seek to reduce edge effects by driving all pixels of the display to one of the extreme black or white states for a substantial period before driving the required pixels to other states. However, the resultant “flash” of solid color is often distracting and undesirable to the viewer. Furthermore, such flashing of the display increases its energy consumption and may reduce the working lifetime of the display.

In contrast, according to the embodiments described herein the position of an image is shifted by only one pixel horizontally and vertically during each update of the display. Accordingly, less energy is required to reduce edge effects, and the update to the display is substantially imperceptible to a viewer thereby improving viewer experience.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A method for reducing an edge effect in an image displayed on an electrophoretic display having an array of pixels, the method comprising:
displaying the image comprising a plurality of pixels on a first subset of the array of pixels;
shifting the value of each of the plurality of pixels by one pixel position in a first horizontal direction and one pixel position in a first vertical direction such that the image is identical but shifted in position to a second subset of the array of pixels; and
shifting the value of each of the plurality of pixels by one pixel position in a second horizontal direction and one pixel position in a second vertical direction,
wherein the second horizontal direction is opposite to that of the first horizontal direction, and
wherein the second vertical direction is opposite to that of the first vertical direction whereby the image is identical but shifted in position to the first subset of the array of pixels.

2. The method of claim 1 further comprising:
shifting the value of each of the plurality of pixels by one pixel position in the second horizontal direction and one pixel position in the second vertical direction such that the image is identical but shifted in position to a second subset of the array of pixels; and
shifting the value of each of the plurality of pixels by one pixel position in the first horizontal direction and one pixel position in the first vertical direction such that the image is identical but shifted in position to the first subset of the array of pixels.

3. The method of claim 1 further comprising:
shifting the value of each of the plurality of pixels by one pixel position in the first horizontal direction and one pixel position in the second vertical direction such that the image is identical but shifted in position to a fourth subset of the array of pixels; and
shifting the value of each of the plurality of pixels by one pixel position in the second horizontal direction and one pixel position in the first vertical direction such that the image is identical but shifted in position to the first subset of the array of pixels.

4. The method of claim 1 further comprising:
shifting the value of each of the plurality of pixels by one pixel position in the second horizontal direction and one pixel position in the first vertical direction such that the image is identical but shifted in position to a fifth subset of the array of pixels; and
shifting the value of each of the plurality of pixels by one pixel position in the first horizontal direction and one pixel position in the second vertical direction such that the image is identical but shifted in position to the first subset of the array of pixels.

5. The method of claim 1 wherein the array of pixels comprises at least one more pixel than the image in the first horizontal direction.

6. The method of claim 1 wherein the array of pixels comprises at least one more pixel than the image in the first vertical direction.

7. The method of claim 1 wherein the array of pixels comprises at least one more pixel than the image in the second horizontal direction.

8. The method of claim 1 wherein the array of pixels comprises at least one more pixel than the image in the second vertical direction.

9. The method of claim 1 wherein the array of pixels is organized as a two-dimensional array of rows and columns.

10. The method of claim 1 wherein the image comprises a bar code.

11. An electrophoretic display comprising:
an array of pixels positioned in a plurality of rows and columns; and
a controller in electrical communication with the array of pixels, the controller configured to reduce an edge effect in an image displayed on the array of pixels by:
displaying the image comprising a plurality of pixels on a subset of the array of pixels;
shifting the value of each of the plurality of pixels by one pixel position in a first horizontal direction and one pixel position in a first vertical direction; and
shifting the value of each of the plurality of pixels by one pixel position in a second horizontal direction and one pixel position in a second vertical direction,
wherein the second horizontal direction is opposite to that of the first horizontal direction, and
wherein the second vertical direction is opposite to that of the first vertical direction.

12. The electrophoretic display of claim 11 wherein the controller is further configured to:
shift the value of each of the plurality of pixels by one pixel position in the second horizontal direction and one pixel position in the second vertical direction; and
shift the value of each of the plurality of pixels by one pixel position in the first horizontal direction and one pixel position in the first vertical direction.

13. The electrophoretic display of claim 11 wherein the controller is further configured to:
shift the value of each of the plurality of pixels by one pixel position in the first horizontal direction and one pixel position in the second vertical direction; and
shift the value of each of the plurality of pixels by one pixel position in the second horizontal direction and one pixel position in the first vertical direction.

14. The electrophoretic display of claim 11 wherein the controller is further configured to:
shift the value of each of the plurality of pixels by one pixel position in the second horizontal direction and one pixel position in the first vertical direction; and
shift the value of each of the plurality of pixels by one pixel position in the first horizontal direction and one pixel position in the second vertical direction.

15. The electrophoretic display of claim 11 wherein the array of pixels comprises at least one more pixel than the image in the first horizontal direction.

16. The electrophoretic display of claim 11 wherein the array of pixels comprises at least one more pixel than the image in the first vertical direction.

17. The electrophoretic display of claim 11 wherein the array of pixels comprises at least one more pixel than the image in the second horizontal direction.

18. The electrophoretic display of claim 11 wherein the array of pixels comprises at least one more pixel than the image in the second vertical direction.

19. The electrophoretic display of claim 11 wherein the image comprises a bar code.

20. The electrophoretic display of claim 19 wherein the edge effect comprises ghosting between at least two bars of the bar code.

21. A method for reducing an edge effect in an image displayed on an electrophoretic display having an array of pixels organized as a two-dimensional array of row pixels and column pixels, the method comprising the steps of:
(a) defining a boundary box within the array of pixels, the boundary box comprising a plurality of row pixels and a plurality of column pixels;
(b) displaying the image on a first subset of the array of pixels, wherein the first subset of the array of pixels comprises two fewer row pixels and two fewer column pixels than the boundary box;
(c) shifting the value of each pixel of the first subset of the array of pixels by one row pixel and one column pixel such that the image is identical but shifted in position relative to the first subset of the array of pixels by one of:
(i) one row pixel to the left and one column pixel upward,
(ii) one row pixel to the right and one column pixel downward,
(iii) one row pixel to the left and one column pixel downward, or
(iv) one row pixel to the right and one column pixel upward;
(d) shifting the value of each pixel of the second subset of the array of pixels by one row pixel and one column pixel such that the image is identical but shifted in position back to the first subset of the array of pixels; and
(e) performing one of step (c) or step (d) alternately during each subsequent update to the electrophoretic display such that the image is only displayed within the boundary box,
wherein each time step (c) is performed the image is shifted in position relative to the first subset of the array of pixels by a different one of (i)-(iv) than the previous time step (c) was performed.

22. The method of claim 21 wherein the boundary box comprises the same number of pixels as the electrophoretic display.

23. The method of claim 21 wherein the image comprises a bar code.

24. An electrophoretic display comprising:
an array of pixels organized as a two-dimensional array of row pixels and column pixels; and
a controller in electrical communication with the array of pixels, the controller configured to reduce an edge effect in an image displayed on the array of pixels by:
(a) defining a boundary box within the array of pixels, the boundary box comprising a plurality of row pixels and a plurality of column pixels;
(b) displaying the image on a first subset of the array of pixels, wherein the first subset of the array of pixels comprises two fewer row pixels and two fewer column pixels than the boundary box;
(c) shifting the value of each pixel of the first subset of the array of pixels by one row pixel and one column pixel such that the image is identical but shifted in position relative to the first subset of the array of pixels by one of:
(i) one row pixel to the left and one column pixel upward,
(ii) one row pixel to the right and one column pixel downward,
(iii) one row pixel to the left and one column pixel downward, or
(iv) one row pixel to the right and one column pixel upward;
(d) shifting the value of each pixel of the second subset of the array of pixels by one row pixel and one column pixel such that the image is identical but shifted in position back to the first subset of the array of pixels; and
(e) performing one of step (c) or step (d) alternately during each subsequent update to the electrophoretic display such that the image is only displayed within the boundary box,
wherein each time step (c) is performed the image is shifted in position relative to the first subset of the array of pixels by a different one of (i)-(iv) than the previous time step (c) was performed.

25. The electrophoretic display of claim 24 wherein the boundary box comprises the same number of pixels as the electrophoretic display.

26. The electrophoretic display of claim 24 wherein the image comprises a bar code.

27. The electrophoretic display of claim 26 wherein the edge effect comprises ghosting between at least two bars of the bar code.
